(19) United States
(12) Patent Application Publication
(10) Pub. No.: US 2024/0356060 A1
(43) Pub. Date: Oct. 24, 2024

(54) LITHIUM ION BATTERIES, SOLID-SOLUTION CATHODES THEREOF, AND METHODS ASSOCIATED THEREWITH

(71) Applicant: Purdue Research Foundation, West Lafayette, IN (US)

(72) Inventors: Kejie Zhao, West Lafayette, IN (US); Nikhil Sharma, West Lafayette, IN (US); Luize Scalco de Vasconcelos, Cupertino, CA (US); Madison Perrin, Lafayette, IN (US)

(21) Appl. No.: 18/641,791

(22) Filed: Apr. 22, 2024

Related U.S. Application Data
(60) Provisional application No. 63/497,328, filed on Apr. 20, 2023.

(51) Int. Cl. H01M 10/0525; H01M 4/02; H01M 4/131; H01M 4/525; H01M 4/62

(52) U.S. Cl. CPC H01M 10/0525; H01M 4/131; H01M 4/525; H01M 4/625; H01M 2004/028

(57) ABSTRACT

Methods of determining ion exchange mechanism in a solid-solution cathode of a Li-ion battery include observing changes in nickel manganese cobalt oxides (NMC) particles of a composite electrode of the Li-ion battery over a period of time using operando optical microscopy, developing a model of the observed changes using multiphysics computational modeling, and determining the ion exchange mechanism based on the observed changes and the developed model. A method of reducing first charge heterogeneous reactions in a Li-ion battery includes increasing electrical conductivity of NMC in an NMC cathode of the Li-ion battery, and/or increasing Li diffusivity in an NMC cathode of the Li-ion battery. A Li-ion battery has a porous composite cathode formed by an NMC cathode having a carbon matrix and NMC particles. The NMC particles do not completely cover the carbon matrix, and in charge cycles after the first charge cycle have homogeneous electrochemical activities throughout the cathode.

### CROSS-REFERENCE TO RELATED APPLICATIONS

This application claims the benefit of U.S. Provisional Application No. 63/497,328 filed Apr. 20, 2023, the contents of which are incorporated herein by reference.

### BACKGROUND OF THE INVENTION

The invention generally relates to lithium ion (Li-ion) batteries and solid-solution cathodes thereof. The invention particularly relates to methods of determining ion exchange mechanisms in solid-solution cathodes of Li-ion batteries, methods of reducing first charge heterogeneous reactions in a Li-ion battery, solid-solution cathodes of Li-ion batteries, and Li-ion batteries equipped with such cathodes.

Nickel manganese cobalt oxides (NMCs) are currently state-of-the-art cathode materials for Li-ion (lithium-ion) batteries due to their high voltage stability and high energy densities. NMC materials, as well as other similar layered transition metal oxides such as nickel cobalt aluminum oxides (NCA), suffer from a capacity loss of about 10% to about 30% in the formation cycle, primarily attributed to kinetic limitations rather than solid electrolyte interphase (SEI) layer formation. Studies using operando synchrotron X-ray diffraction (XRD) and nuclear magnetic resonance (NMR) spectroscopy have indicated that this kinetic limitation originates from an exceedingly low Li mobility at the fully lithiated state, which prevents complete reversal of the state-of-charge (SOC) at practical C-rates. Regardless of the material system, it follows from Fick's law that monotonically increasing diffusivity leads to an asymmetric rate-capability. It has also been observed through NMR that even though NCA does not undergo a phase transition, a bimodal composition distribution appears during charging. Conversely, during discharging, the Li distribution was homogeneous. A recent study has suggested a different explanation for the bimodal distribution in non-phase transforming layered oxide cathodes, which is based on the strong dependence of the interfacial reaction kinetics on the Li concentration and small variations in the initial Li concentration across particles. In addition to the first cycle capacity loss, non-uniform Li reactions can induce local structural damage. In light of these observations, it is clear that the Li kinetics in solid solution materials can be nuanced, leading to short- and long-term consequences on the battery performance.

While previous analyses have shown bimodal composition dynamics in solid solution cathodes, several open questions remain, such as the length scale of the composition heterogeneity (inter-particle or intra-particle), how this phenomenon progresses over cycles at practical C-rates, and whether there exist theories sufficient to explain the mesoscale composition spatiodynamics across the electrode. Therefore, it would be desirable if there were improved approaches to investigate these mechanics to have a deeper insight into the reaction heterogeneity of porous electrodes and electrochemical conditioning for layered oxide cathodes, and in so doing describe methods of obtaining improvements in electrochemical cells that reduce capacity loss during the initial charge cycle.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, solid-solution cathodes of Li-ion batteries, Li-ion batteries equipped with such solid-solution cathodes, and methods associated therewith, as nonlimiting examples, determining ion exchange mechanisms in a solid-solution cathode of a Li-ion battery and methods of reducing first charge heterogeneous reactions in a Li-ion battery.

According to a nonlimiting aspect, a method of determining ion exchange mechanism in a solid-solution cathode for a Li-ion battery includes observing changes in nickel manganese cobalt oxides (NMC) particles of a composite electrode of the Li-ion battery over a period of time using operando optical microscopy, developing a model of the observed changes using multiphysics computational modeling, and determining the ion exchange mechanism based on the observed changes and the developed model.

According to another nonlimiting aspect, a method of reducing first charge heterogeneous reactions in a Li-ion battery includes increasing electrical conductivity of NMC particles in an NMC cathode of the Li-ion battery, and/or increasing Li diffusivity in the NMC cathode of the Li-ion battery.

According to still another nonlimiting aspect, a Li-ion battery having a porous composite cathode includes an NMC cathode forming the porous composite cathode. The NMC cathode includes a carbon matrix and NMC particles. The NMC particles do not completely cover the carbon matrix. Intensity of reaction heterogeneity in the NMC cathode is proportional to a value of electrical conductivity of the NMC particles. Incomplete Li intercalation after the first charge cycle promotes electrical conductivity of the NMC particles in subsequent charge cycles, resulting in homogeneous electrochemical activities throughout the porous composite cathode.

These and other aspects, arrangements, features, and/or technical effects will become apparent upon detailed inspection of the figures and the following description.

### BRIEF DESCRIPTION OF THE DRAWINGS

FIGS. 1A-1C represent pixel intensities of NMC particles in operando optical microscopy images across the first two cycles at C/20. FIG. 1A represents the average normalized pixel intensity of particles 1-14 marked in FIG. 1B. The scale bar is 10 μm. The average intensity increases with delithiation (charging) and decreases with lithiation (discharging). FIG. 1C represents the normalized pixel intensity of individual particles (top panel) and corresponding slope (bottom panel). The first charge is characterized by an asynchronous step function (left plot in the top panel) and single peaks (left plot in the bottom panel). In contrast, subsequent (dis) charges proceed via a gradual, synchronous behavior.

FIG. 2 contains operando optical images of the first charge (scale bar 10 μm) from a pristine state (image a) to a fully delithiated state (image j) in the course of 20 hours. The individual sections of originally split particles (dashed circles) delithiate at different times. The smaller fragments (likely having a worse electrical connection to the matrix) delithiated later.

FIG. 3 contains operando optical images of the second charge (images a to d) and third charge (images e to h) (scale bar 10 μm). The uniform intensity change indicates that particles delithiated synchronously.

FIGS. 4A-4D represent a schematic and parameters of computational modelling. FIG. 4A is a schematic representation of a 2-D cathode cross-section geometry. FIG. 4B is a graph showing electrical conductivity (K_{NMC}) of NMC as a function of state of charge (SOC). FIG. 4C is a graph showing diffusivity of NMC versus the SOC. FIG. 4D is a graph showing Li concentration at the locations on the surface of the topmost particles in FIG. 4A as a function of the charging time.

FIG. 5 illustrates computational modeling of the spatial distribution of Li in the NMC secondary particles.

FIGS. 6A-6C contains scanning electron microscopy (SEM) images of the NMC cathode before (FIG. 6A) and after (FIGS. 6B and 6C) after surface polishing. Scale bars correspond to 10 μm.

FIGS. 7A-7C schematically illustrate a setup of a closed cell for in-situ optical experiments conducted in accordance with certain nonlimiting aspects of the invention.

FIG. 8 schematically illustrates an experimental setup for operando optical imaging of battery electrodes.

FIG. 9 represents a potential curve and corresponding optical images of an NMC cathode during its first two cycles at C/20.

FIG. 10 shows intensity changes at three regions with the state of charge.

FIGS. 11A-11C show observations of the asynchronous first charging and particle cracking of NMC811. The white scale bar is 10 μm.

FIG. 12 represents a 3D model of a single surface polished NMC secondary particle.

### DETAILED DESCRIPTION OF THE INVENTION

The intended purpose of the following detailed description of the invention and the phraseology and terminology employed therein is to describe what is shown in the drawings, which relate to one or more nonlimiting embodiments of the invention, and to describe certain but not all aspects of what is depicted in the drawings, including the embodiment(s) to which the drawings relate. The following detailed description also describes certain investigations relating to the embodiment(s), and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

The following describes investigations and results thereof that employed operando optical microscopy paired with multiphysics modeling that provided insight into the reaction heterogeneity of porous electrodes and electrochemical conditioning for layered oxide cathodes, as well as methods of obtaining improvements in electrochemical cells that reduce capacity loss during the initial charge cycle.

Composition dynamics regulate the accessible capacity and rate performance of rechargeable batteries. Heterogeneous Li reactions can lead to non-uniform electrochemical activity and amplify mechanical damage in the cell. In the investigations reported below, operando optical microscopy was employed as a laboratory tool to map the spatial composition heterogeneity in a solid-solution cathode for Li-ion batteries. The investigations were conducted at slow charging conditions to investigate the thermodynamic origins. It was observed that the active particles charge asynchronously with reaction fronts propagating on the particle surfaces during the first charging cycle, while subsequent (dis) charge cycles transitioned to a synchronous behavior for the same group of particles. Such a transition was understood by computational modeling, which incorporated the dependence of Li diffusivity and interfacial reaction on the state of charge. The optical investigations and theoretical modeling provided insight into the reaction heterogeneity of porous electrodes and electrochemical conditioning for layered oxide cathodes.

### Operando Optical Microscopy

The easy access, low cost, and non-destructiveness of optical microscopy make it a suitable technique for conducting exhaustive and exploratory studies in Li-ion batteries and has been gaining popularity in recent years. In the investigations reported herein, the change in the reflected light intensity from a nickel manganese cobalt oxide (NMC) cathode was tracked continuously over three days and used to infer local composition changes during slow charging over cycles, starting with the formation cycle. The dependence of the reflected light intensity on the Li content has been previously verified in a variety of active materials, including graphite, silicon, and LiCoO₂. The operando experiments of these investigations revealed that NMC particles react asynchronously during the first charge of the formation cycle but transition towards uniform (synchronous) reactions in subsequent (dis) charge sequences. Numerical simulations showed that solid-state diffusion limitations cannot explain these observations solely and require a spatially varying electric potential across the electrode surface. The exceedingly low electrical conductivity of NMC in its pristine state and partial surface coverage of NMC by the conductive matrix can lead to such variation, producing the asynchronous reactions during the first charge. The transition to synchronous reactions happened naturally as a consequence of the incomplete composition reversal in the first cycle, which caused an increase in the baseline electrical conductivity and electric field homogenization. These findings suggested that improving the electrical conductivity of NMC and optimizing the conductive matrix coverage could prevent the first charge heterogeneous reactions and their detrimental consequences.

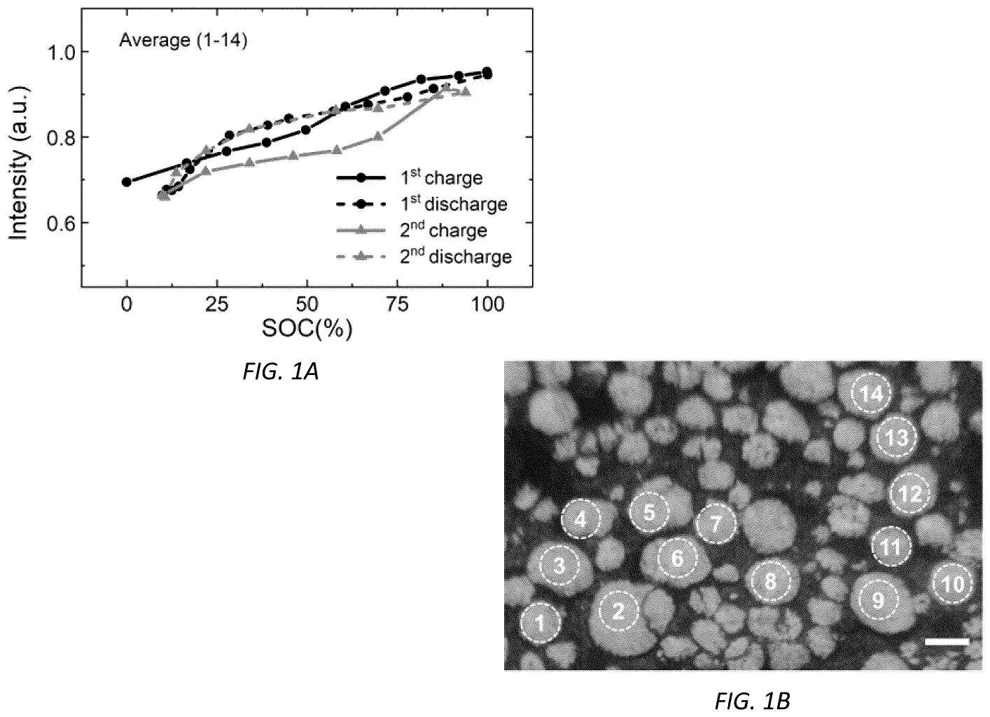

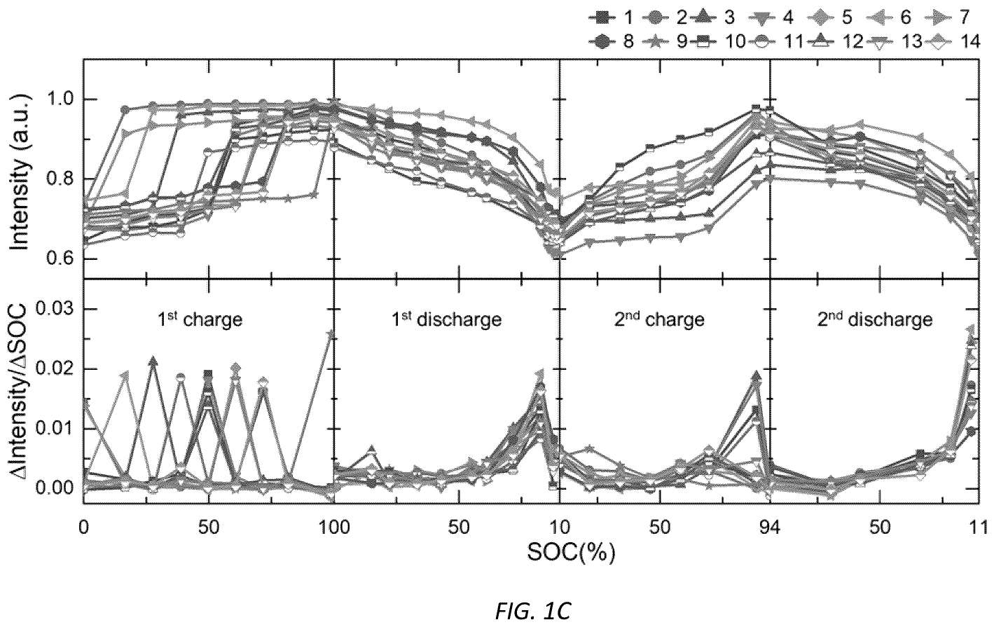

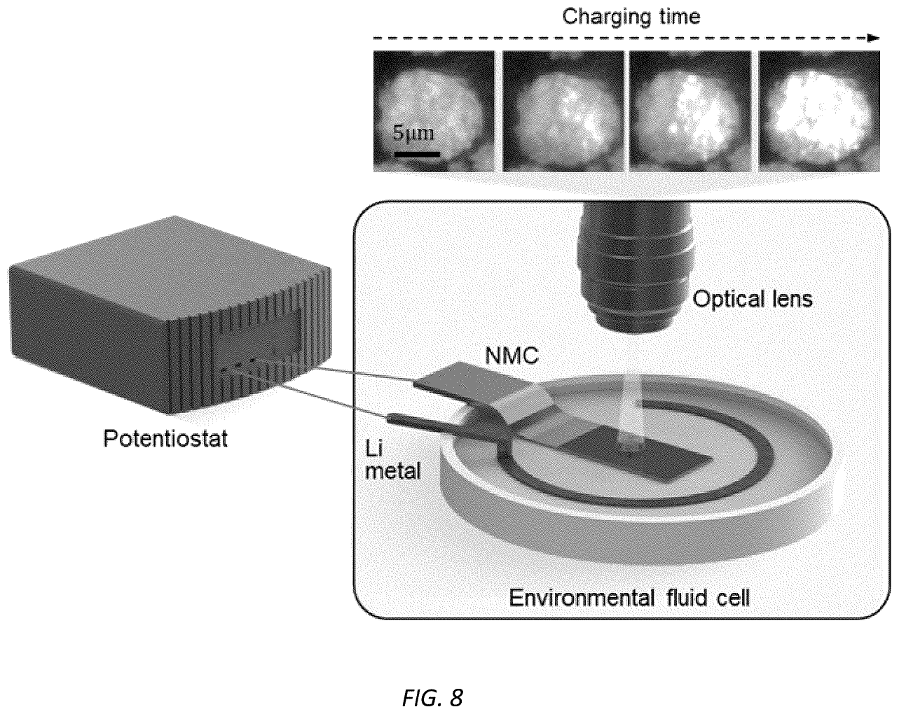

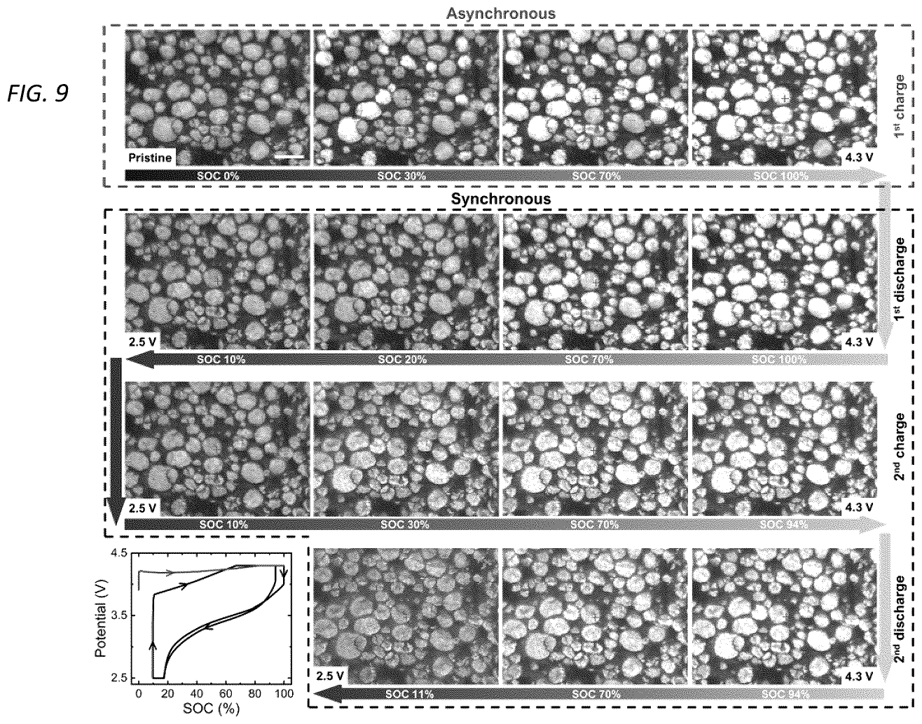

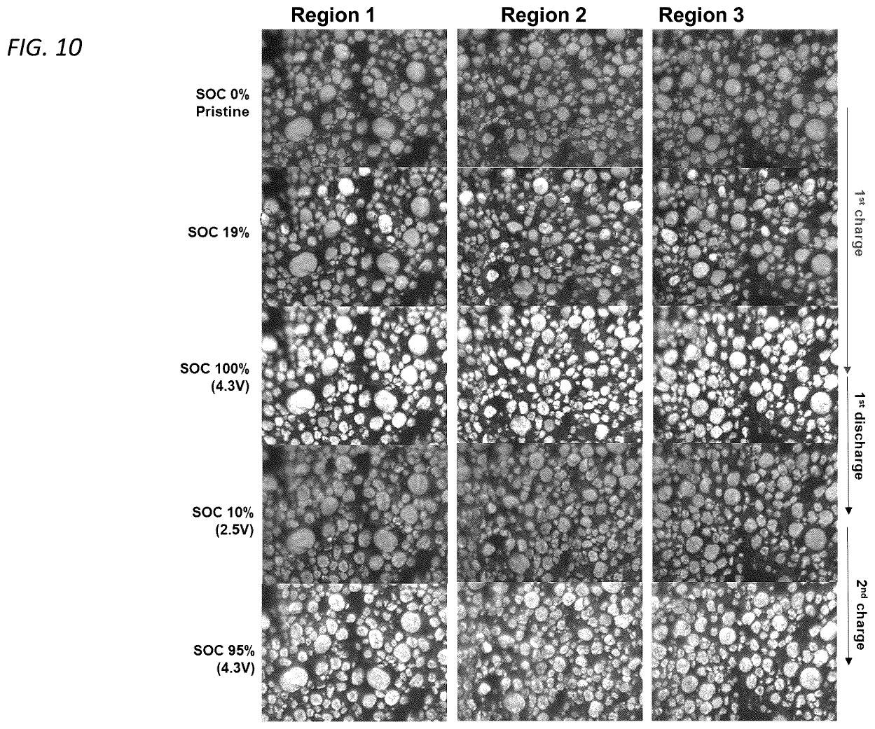

The investigations recorded optical images of an NMC cathode inside a fluid cell with a Li metal anode upon cycling at a C-rate of C/20 (schematic in FIG. 8). The NMC cathode was a polished composite electrode of LiNi_{0.5}Mn_{0.3}Co_{0.2}O₂ (NMC 532), active material particles, polymer binder, and carbon black conductive additive. The composition spatiodynamics of the electrode were analyzed by the observed change in reflected light intensity. To quantify the change in the perceived brightness, the pixel intensity of fourteen NMC particles (dashed circles in FIG. 1B were tracked. The values of pixel intensity R+G+B (Red+Green+Blue) were measured in the range of 0-255 and normalized by 255. The average normalized intensity of the fourteen particles as a function of the cell SOC is shown in FIG. 1A. Note that there were certain limitations of the optical imaging technique such as the evolution of particle topography, small deviations in the lens focus, and a limited number of particles in the field of view. Therefore, the absolute difference in the average intensity at different charging states in FIG. 1A is not so meaningful. Nevertheless, there is a clear correlation between intensity and SOC, which suggests a monotonic dependence on Li content (i.e., an increase in intensity is directly proportional to a decrease in Li concentration). If individual particles were inspected instead of looking at the average intensity of all the particles, the intensity was widely non-uniform during the first charge. The top panel of FIG. 1C shows that particles bright up abruptly and asynchronously (marked by sudden jumps in the intensity curves). These jumps in intensity do not occur in the following (dis) charge sequences despite the cell operating at the same C-rate (C/20). Instead, the intensity changes gradually with the SOC, which indicates that all particles react at roughly the same time, and at a similar rate. The asynchronous-to-synchronous transition was most apparent when inspecting the slope of the intensity vs. SOC curves (bottom panel of FIG. 1C). For the first charge (left plot), the pristine particles were inactive for most of the SOCs (slope was practically zero throughout) except for one peak when the intensity abruptly switches from its baseline to its maximum value. This behavior was quite different in the following half-cycles, where particles react coherently (largely uniform Δintensity/ΔSOC). The voltage curve and optical images are summarized in FIG. 9. This peculiar phenomenon happens across the entire surface electrode (optical images of different areas of the sample in FIG. 10). Under the constant voltage step at the end of each (dis) charge sequence, there was a marked change in the intensity slope, which was likely a result of the surface saturating faster than the bulk under this condition.

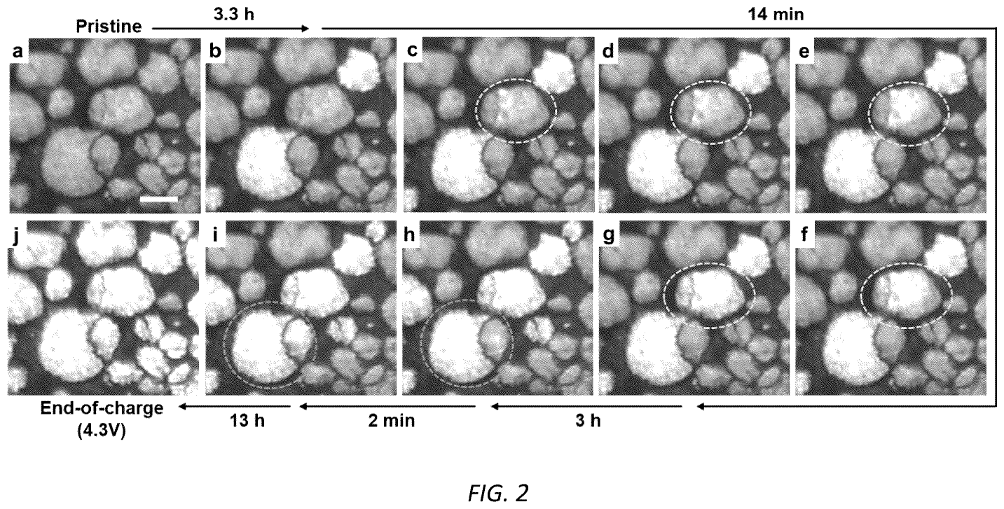

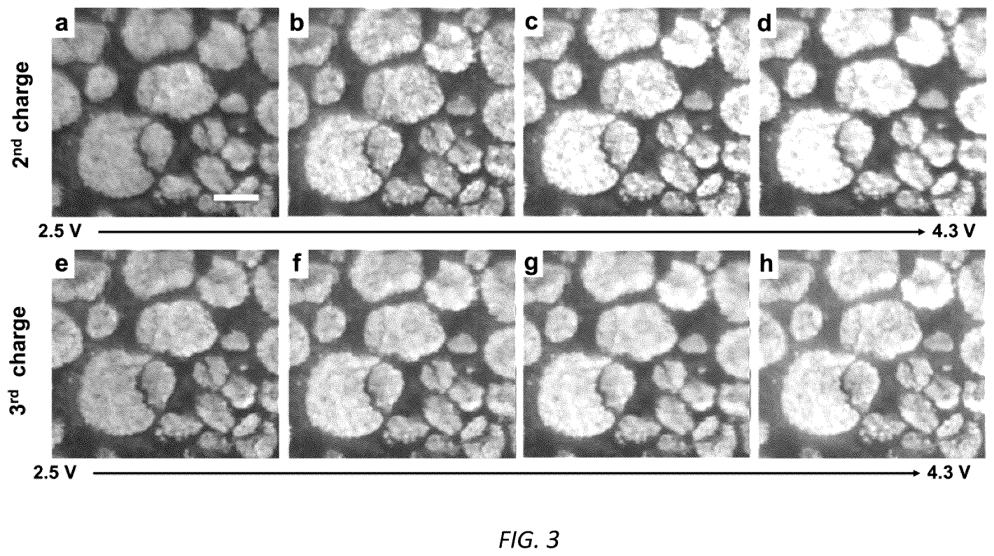

To understand the intra-particle and inter-particle composition spatiodynamics during the first charge, close-up optical images (images a through j in FIG. 2) were inspected. Note that the two cracked particles enclosed by dashed lines were already damaged in their pristine state (image a), and their cracks were not a result of Li reactions. The images show that the intensity surge occurs at different stages of the first charge for particles belonging to the same neighborhood. For instance, the particle encircled in images c through g undergoes the intensity jump after 3.3 hours into the charging process, while a neighboring particle, the smaller section of a particle encircled in images h and i did not react until 3.2 hours later. Many surrounding particles display no sign of intensity change even after 13 hours of charging (image i), and this interparticle heterogeneity exists throughout most of the operating range. The Li distribution appears to quickly homogenize within each particle (less than 14 min for the particle encircled in images c through g and 2 min for the right section of the cracked particle encircled in images h and i). The larger sections of the fragmented particles tend to react earlier than their counterparts, which may be related to the smaller sections having a worse connection to the electrically conductive carbon network of the cathode. FIG. 3 shows a different behavior of the second and third charge cycles than that from the first charge. The intensity change was gradual and uniform across and within all the particles indicating homogeneous composition dynamics.

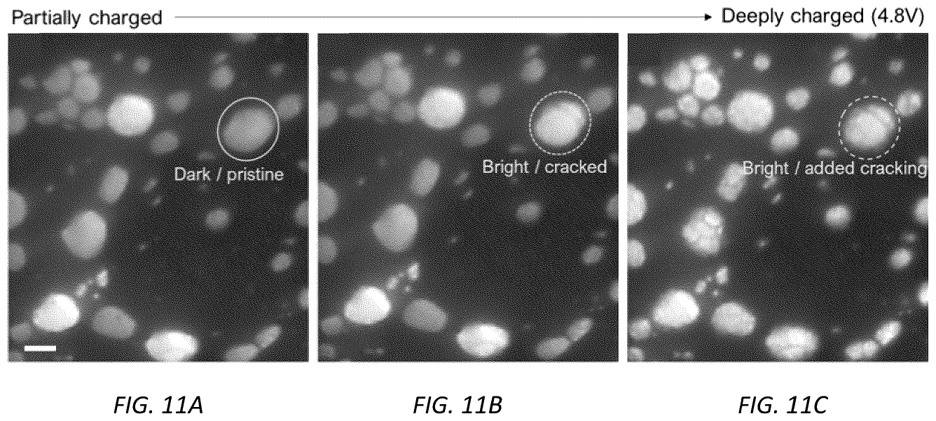

It was verified that this asynchronous Li deintercalation during the first charge also occurs for different NMC transition metal compositions (LiNi_{0.8}Mn_{0.1}Co_{0.1}O₂-NMC811), electrolytes, and C-rates (see, e.g., FIGS. 11A-11C). Notably, FIG. 1A (potential with respect to SOC curve in FIG. 9) shows that roughly 10% of the capacity was not recovered at the end of the first discharge, consistent with previous studies. The capacity loss for the second cycle was negligible, providing a high coulombic efficiency that was typically seen for NMC in the later cycles. Since the operating voltage window of 4.3-2.5V was chosen, extreme structural degradation in the NMC532 particles was not observed (typically occurring at a higher voltage of 4.6V or a lower range of 1.7V). However, large cracks were observed in NMC811 particles even at moderate voltages (FIGS. 11A-11C). The fracture timing correlated precisely with the intensity surge, which was further evidence of the intensity dependence on Li content.

The above results agreed with previous observations made in similar materials that a bimodal composition distribution exists during the first charge that does not show up during the first discharge. However, it was found that the earlier justification that the effect originates from Li mobility limitations was insufficient to explain the phenomenon observed. In these investigations, the cathode was fully submerged in the electrolyte solution, and Li-ions were available throughout the entire surface of the particle being imaged. Thus, solid-state diffusion alone could not explain the surface and interparticle heterogeneities. Hence, this phenomenon was investigated further using computational modeling to identify its underlying mechanism.

### Computational Modeling

Consider the Butler-Volmer kinetics for the surface charge transfer at the interface of NMC and the liquid electrolyte,

$${i}_{BV} = {i}_{0} ( exp ( \frac{{α}_{f} F η}{RT} ) - exp ( \frac{- {α}_{c} F η}{RT} ) ) , \qquad Eq . ( 1 )$$

$$η = {ϕ}_{s} - {ϕ}_{l} - {E}_{eq} , \qquad Eq . ( 2 )$$

$${i}_{0} = {F ( {k}_{C} )}^{{α}_{a}} {( {k}_{a} )}^{{α}_{c}} {( {c}_{max} - c )}^{{α}_{a}} {( c )}^{{α}_{c}} {( \frac{{c}_{l}}{{c}_{l , ref}} )}^{{α}_{a}} , \qquad Eq . ( 3 )$$

where i_{BV} is the redox current through the surface of the NMC particles, i₀ is the exchange current density, η is the electrochemical overpotential, ϕₛ is the local electric potential at the NMC particle reaction surface, ϕₗ is the local electrolyte potential, and E_{eq} is the equilibrium potential at a given local Li concentration when the active material and the electrolyte were at electrochemical equilibrium. The spatial variation of ϕₛ or ϕₗ for a thick cathode or during a high C-rate can lead to dissimilar charging behavior of NMC particles. However, at the slow charging (C/20) condition, the spatial variation of ϕₛ or ϕₗ should be insignificant unless electrical obstruction or ionic obstruction exists across the cathode.

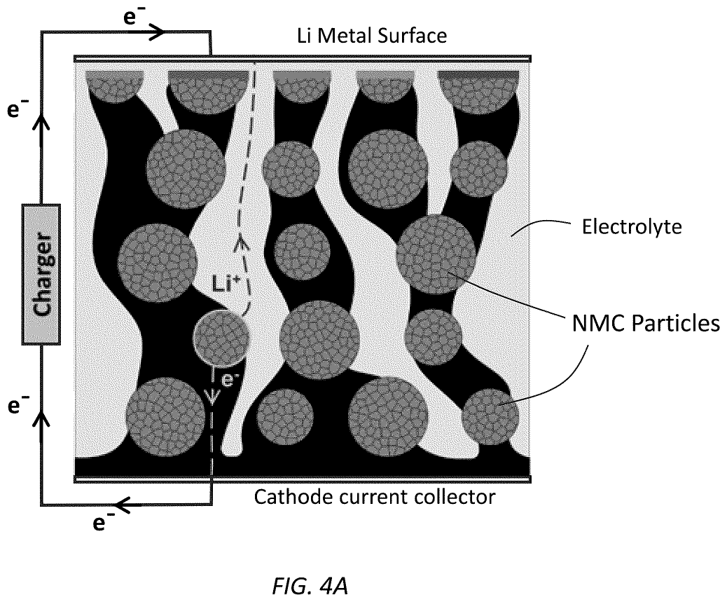

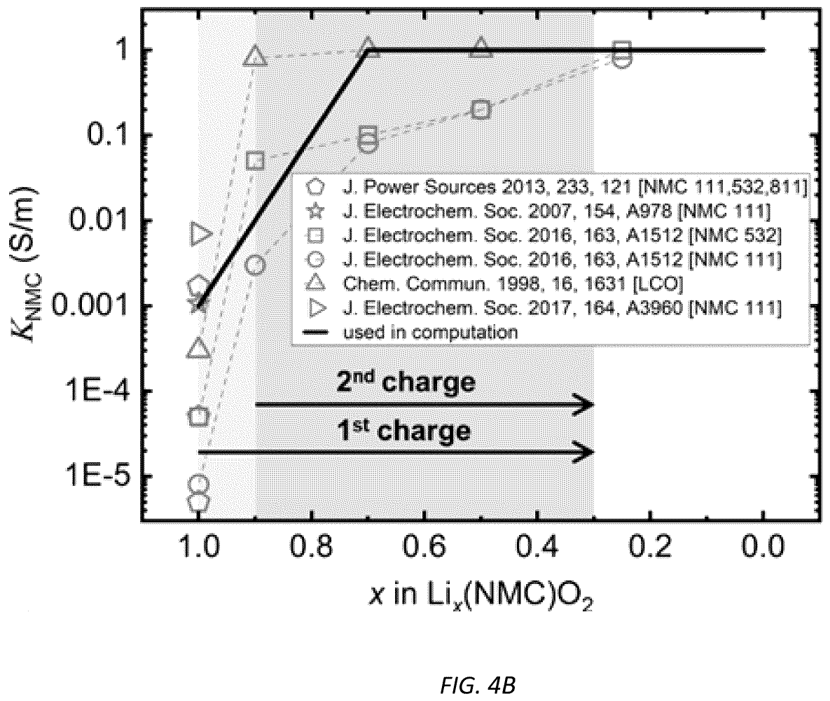

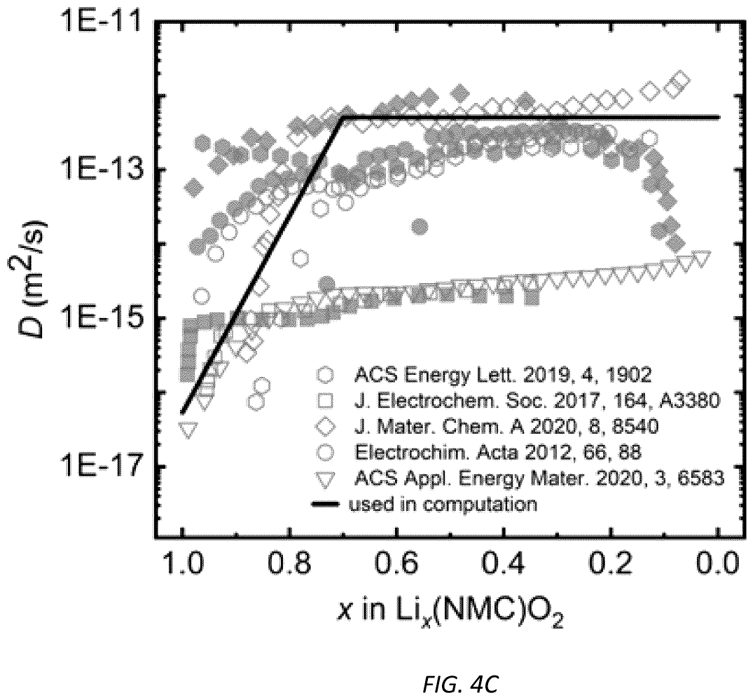

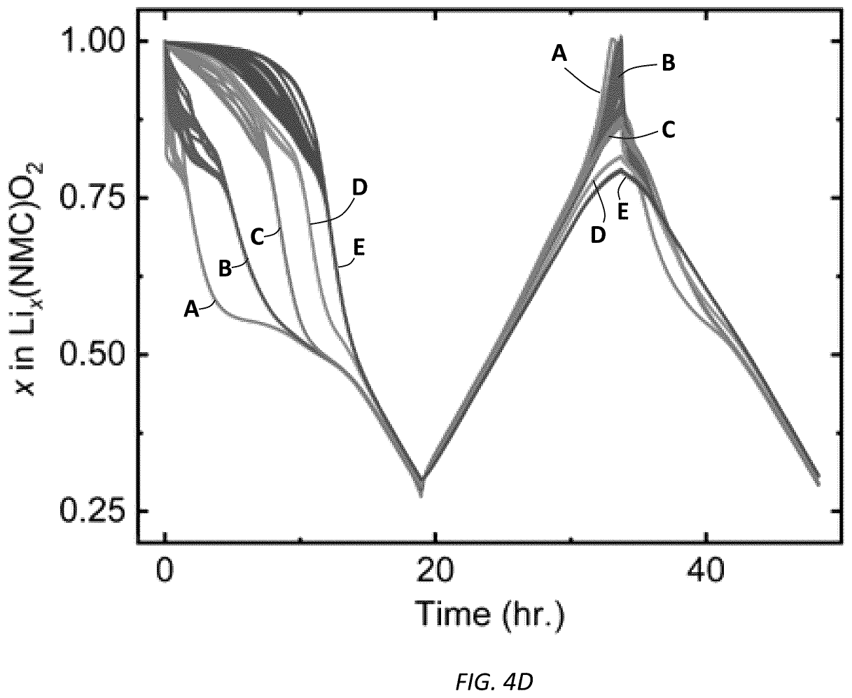

FIG. 4A schematically shows a 2-D cathode cross-section geometry where polycrystalline NMC particles were embedded in a carbon network (black), surrounded by the electrolyte, and connected with a cathode current collector at the bottom. The interfacial reaction occurs at the NMC surface: in direct contact with the liquid electrolyte, and at the porous carbon binder interface. The shell around NMC secondary particle conducts electrons for the interfacial reaction. FIG. 4B shows electrical conductivity (K_{NMC}) of NMC as a function of SOC. The low value of K_{NMC} compared to carbon binder (about 10⁴ S/m) creates electrical resistance in the cathode leading to the asynchronous first charging behavior. The lower Li content at the first cycle compared to the pristine state leads to higher starting electrical conductivity for the following charge. This difference helped minimize the asynchronous behavior in later cycles at the same C-rate. FIG. 4C shows the diffusivity of NMC versus the SOC. The black curve was the curve used in the computational model. The low diffusivity in the low SOC region (x=1.0˜0.8 in Lᵢₓ(NMC)O₂) led to capacity loss after the first cycle. FIG. 4D shows the Li concentration at locations on the surface of the topmost particles in FIG. 4A as a function of the charging time. The variation in the carbon conducting network to the topmost NMC particles resulted in an asynchronous charging only during the first charge, in agreement with the experimental results.

The morphological features of the carbon binder network in commercial use electrodes were generally heterogeneous: non-uniform distribution and varying tortuosity across the cathode, connectivity/dead ends, and incomplete NMC particle coverage. Since the NMC materials have electrical conductivity several orders of magnitude smaller than that of conductive carbon binder matrix, one of the primary sources of obstruction to the electrically conductive network was the NMC particles. To simulate this effect, the 2D model depicted in FIG. 4A was created with the NMC particles on the top surface (closest to the “Li Metal Surface”) experiencing varying degrees of electrical resistance from the conducting network. The rightmost particle (particle “E”) experienced the largest degree of electrical obstruction, with four NMC particles obstructing its conductive network. Conversely, the leftmost particle (particle “A”) had a direct carbon binder connection to the current connector. Depending on the magnitude of the electrical conductivity of the NMC particles, these differences in the conductive network led to spatial variations in the electric potential (ϕₛ), altering the local overpotential (η) and thus generating dissimilar interfacial currents (i_{BV}) at the NMC particle surfaces (based on equations (1)-(3)). Hence, the active particles in the same neighborhood but with different contacts with the conductive network can experience the onset of reactions at different times. Note that it was not intended to capture all the explicit microstructural details in a commercial composite cathode with the model in FIG. 4A. Instead, the goal was to replicate the fact that the electrically conductive agent nonuniformly covers the active particles. The electrochemical modeling was based on the theory developed by Doyle et al., J. Modeling of Galvanostatic Charge and Discharge of the Lithium/Polymer/Insertion Cell. J. Electrochem. Soc. 1993, 140 (6), p. 1526-1533.

The Li diffusivity in NMC was highly concentration-dependent as shown in FIG. 4C (symbols represent literature data, and a continuous black line is the curve adopted in the model). A general trend was that Li diffusivity in NMC was low at the start of charging (x˜1 in Liₓ(NMC)O₂) and increased as the charging proceeded (1>x>0.2˜0.5 in Liₓ(NMC)O₂). This observation had a mechanistic explanation in terms of the deviancy diffusion mechanism where the Li mobility varied with the square of the number of vacancies. In the case of silicon, it was previously demonstrated how the concentration-dependent diffusivity can create an intrinsically asymmetric performance during charging and discharging. With the Li diffusivity increasing with the SOC, the time needed to fully discharge can be orders of magnitude higher than the charging time regardless of the type of boundary condition (Neumann/Dirichlet). For NMC, the lower diffusivity at high Li concentrations made it challenging to reinsert all the Li back into the NMC lattice even at slow C-rates. After losing a fraction of the capacity at the end of the first cycle, the system stayed at higher values of Li diffusivity for subsequent cycles, thus preventing further capacity loss in subsequent cycles. A similar trend held for the reaction rate constant of NMC for the surface charge transfer. A prior study showed that the variation of the reaction rate could result in the autocatalytic effect and fictitious phase separation in a layered oxide cathode.

FIG. 4B shows literature reports of the electrical conductivity of NMC materials (symbols) and the curve adopted in the computational model (continuous black line). The conductivity was several orders of magnitude lower in the pristine state than in the partially charged (delithiated) state. This behavior was similar to LiCoO₂ and attributed to the transition from a semiconductor-like behavior to a metallic character caused by the initial Li removal. Due to the capacity loss after the first cycle, the NMC particles remained at a significantly higher electrical conductivity (in addition to higher diffusivity) for the start of the second charge (FIGS. 4B and 4C). Hence, the low electrical conductivity of pristine NMC may explain the first charge asynchronous reactions. At the same time, the capacity loss was linked with the transition to synchronous reactions by preventing the NMC from reaching lower values of electrical conductivity (at a pristine state).

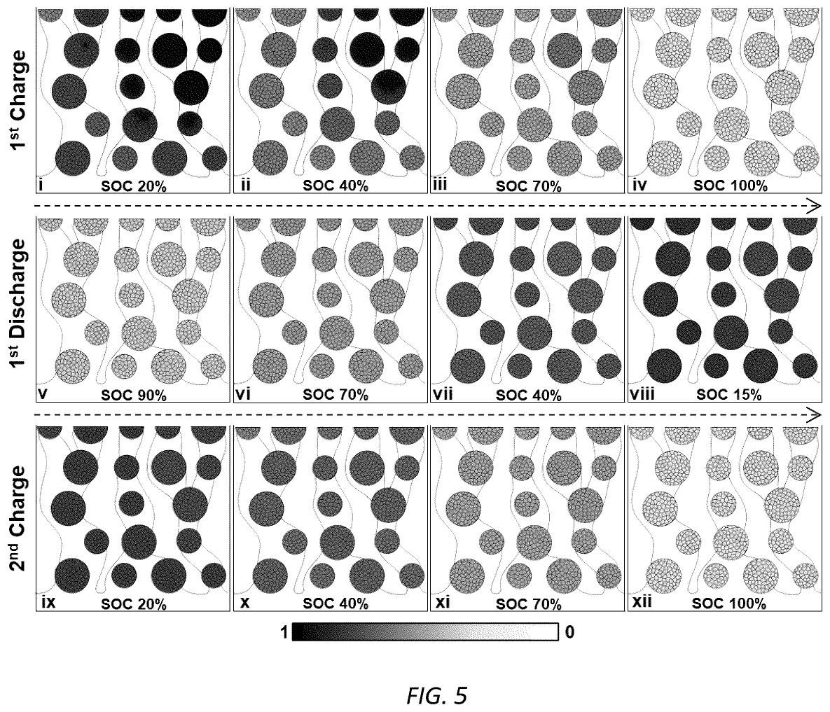

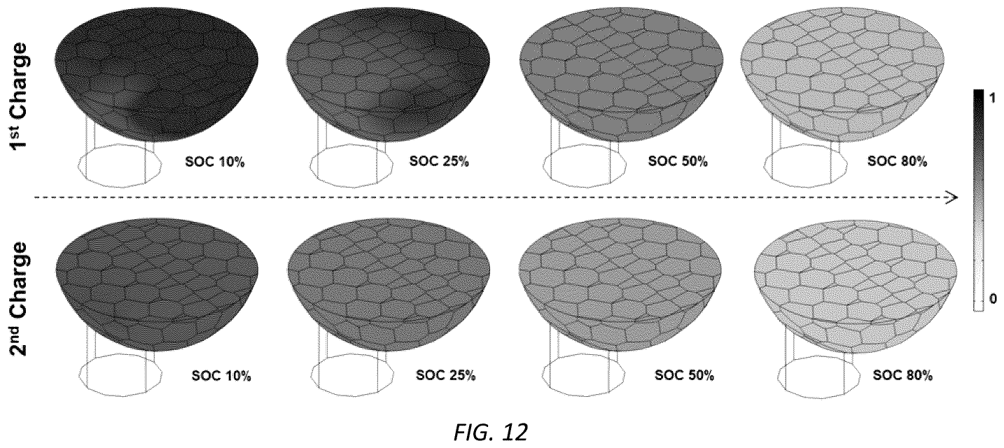

The model in FIG. 4A was cycled by enforcing a constant current at the Li source surface corresponding to a C-rate of C/20. FIG. 4D shows the normalized surface concentration of Li with time for the particles in FIG. 4A. As per the hypothesis, the electrochemical activities were delayed with the increment of the electrical resistance along the path to the current collector (i.e., the leftmost top particle reacts first, and the rightmost top particle reacts last). This effect did not appear in the second charge because the incomplete Li intercalation at the end of the first cycle leads to the higher electrical conductivity at the start of the second charge (range indicated in the darker grey shade for the second charge in FIG. 4B). In the absence of first cycle capacity loss, the asynchronous reactions would have continued into subsequent cycles. FIG. 5 shows the spatial distribution of Li concentration in the contour map of the NMC cathode, as well as the Li profiles on the surface of the NMC particles at different states of charge. The first charge (top row) exhibited highly heterogeneous (intra- and inter-particle) compositional dynamics where Li extraction started from the pristine state (i) and ended at a higher SOC on the right side (iv). In contrast, the subsequent (dis) charges (second and third rows) show synchronous behavior. Due to the exceedingly low electrical conductivity of the NMC particles in the pristine state, the composition dynamics during the first charge were extremely sensitive to the characteristics of the carbon binder network. Low spatial interconnectivity of carbon binder within the electrode and incomplete coverage around NMC particle led to highly heterogeneous Li distribution throughout the electrode. The intraparticle heterogeneity was also observed in a 3D single-particle model (FIG. 12).

At the slow C/20 rate, the reaction rate constant (k) contributed to the heterogeneity of the reactions in the model but not significantly. Structural degradation of the NMC secondary particles was not considered in the computational study. Mechanical damage at the interphase of NMC and carbon binders, or the breakdown of the secondary particles, can further modulate the asynchronous reaction in the first charge, which was not considered in the present study. The change in the carbon binder properties during (dis) charge, interfacial debonding, microstructural evolution of carbon binder network, and particle crack generation were vital occurrences during the first charge, which can regulate the asynchronous kinetics of NMC.

The mechanistic understanding was implemented in 2D/3D models and replicated the experimental observations. From these investigations, it was concluded that the asynchronous and synchronous Li activities were general phenomena for porous electrodes using layered metal oxide cathodes and were crucial factors determining rechargeable batteries' capacity and rate performance.

### Examples

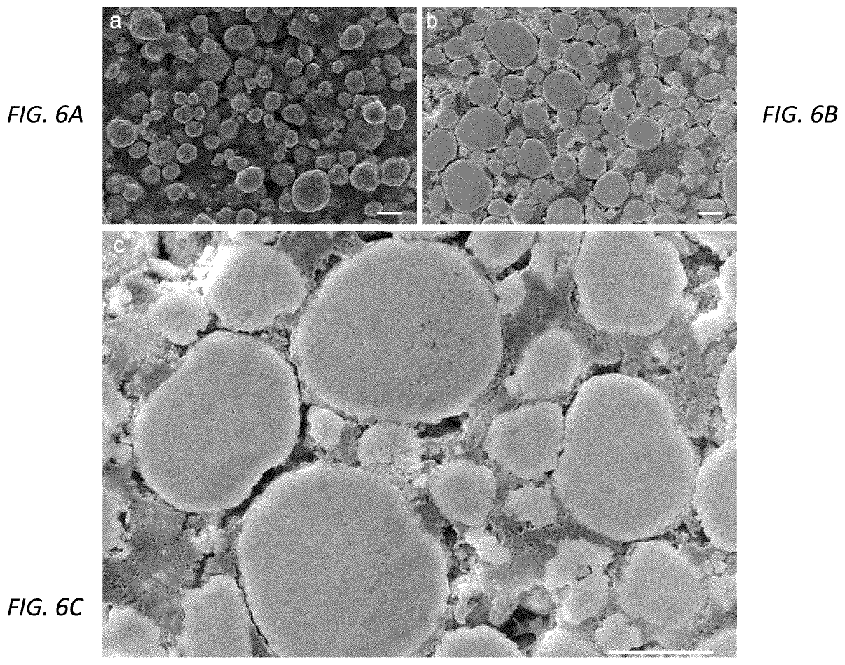

Sample preparation: The NMC532 cathode used in the main experiment was prepared as follows. A slurry containing as-received LiNi_{0.5}Mn_{0.3}Co_{0.2}O₂ powder (NMC532, Toda America), carbon black (CB, Denka), polyvinylidene fluoride (PVDF, Solvay, 5130), and n-methyl-2-pyrrolidone (NMP, Sigma Aldrich) was cast on a battery-grade aluminum sheet by slot-die coating. The areal loading was 12.5 mg per cm², and the weight ratios were 90 wt. % NMC532, 5 wt. % PVDF, and 5 wt. % CB. The calculated porosity of the cathode was 55%. A strip of 0.8 cm² area was cut out of the cathode and ion polished to achieve a flat and smooth surface suitable for high magnification optical imaging. The scanning electron microscopy (SEM) images in FIGS. 6A-6C show the surface morphology pre- and post-polishing.

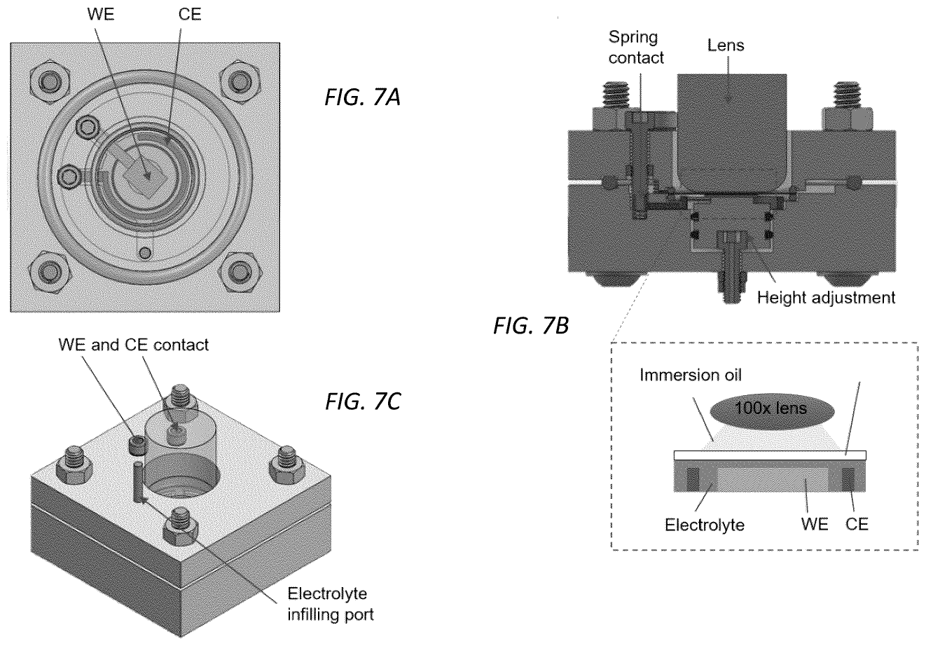

Operando setup and experiments: The cathode sample was then kept overnight in a vacuum oven at 80° C. to remove moisture. Next, the sample was transferred to an argon-filled glovebox (O₂ and H₂0<1 ppm) and fixed to the center of a fluid cell to serve as the working electrode (WE) and wrapped around by a non-contacting Li metal ribbon (99.9% Li, Sigma Aldrich) which served as the counter electrode (CE). The cell was filled with a non-volatile electrolyte consisting of 0.75M of LiPF₆ in propylene carbonate (PC, Sigma Aldrich) and ethylene carbonate (EC) with a 1:1 weight ratio. The cell was cycled using a potentiostat and optical images acquired every minute at fixed positions. At the cut-off voltages (high 4.3V and low 2.5V), a constant potential was maintained until the current drops to ⅕ of the galvanostatic current to achieve a better coulombic efficiency. Tests were conducted at C/20 and C/10 (1C=200 mA/g). 100% SOC was defined as the capacity at the end of the first charging of the pristine sample after the voltage hold. In addition to the main experiment, additional tests were conducted to verify the generality of the findings for different test conditions. To test a more commonly used but volatile diethyl carbonate (DEC) based electrolyte, a sealed fluid cell that can be tested outside the glovebox without air contamination was designed. FIGS. 7A-7C schematically represent, respectively, top, perspective, and cross-sectional views of the sealed fluid cell, an depict a cathode (working electrode; WE) on a movable platform, and an anode (counter electrode; CE) lying on a circumferential groove in the electrolyte-filled chamber. Testing verified that the experimental observations were also repeatable for different transition metal ratios (LiNi_{0.8}Mn_{0.1}Co_{0.1}O₂, NMC811, MTI Corp.), types of binder (Polyacrylic acid, PAA, Sigma Aldrich), and polishing procedures.

FIG. 8 shows the experimental setup for operando optical imaging of battery electrodes while undergoing controlled electrochemical cycling in an inert gas environment. The fluid cell contains a surface polished NMC532 cathode enclosed by a Li metal ribbon inside an electrolyte container connected to a potentiostat. The continuous imaging of the cathode's top surface showed that the optical reflectivity of the NMC particle changes with the Li content in the cathode.

As seen in FIG. 9, the reflectivity of the NMC particles changed with the SOC leading to the varying pixel intensity. During the first charge (first row, at top), particle intensities changed asynchronously and abruptly from dark to bright (white scale bar 20 μm). Distinctively, subsequent (dis) charge processes proceeded through a gradual and synchronous change in reflectivity. The high reflective intensity corresponded to the delithiated state (end-of-charge, 4.3V), and the low intensity corresponded to the lithiated state (end-of-discharge, 2.5V).

FIG. 10 shows the intensity changes at three different regions (“Region 1,” “Region 2,” and “Region 3”) of the cathode with the state of charge. FIG. 10 provides evidence of asynchronous charging of NMC particles in multiple regions. The dashed circles in the images for Regions 1, 2, and 3 corresponding to a SOC of 19% identify particles that underwent a sudden change of the optical reflection during the initial 19% charging.

FIGS. 11A-11C shows observations of the asynchronous first charging and particle cracking of NMC811. At a first timestep (FIG. 11A) there were three bright particles (reacted) while the rest remained dark (unreacted). From the first to second timestep (FIG. 11A to FIG. B) the circled particle lit up (reacted), and at the same time, a large crack appeared. At the end of deep delithiation (FIG. 11C), there was extensive cracking throughout the cathode.

Theoretical modeling: The Butler-Vomer equation represents the charge transfer kinetics occurring at the interface between the active material NMC and the electrolyte. CB partially covered the surface of the NMC particles, and the rest of the NMC surface was exposed to the electrolyte. Li-ions transporting through the electrolyte met the electrons traveling from the cathode current collector through the CB domain on the surface of the NMC particles. Because of the inhomogeneous coverage of the NMC particle surface by the CB, electron transport in NMC was considered through a thin shell with a thickness of s on the surface. The electric potential (ϕₛ) variation in the thin shell has a relationship with the surface current (i_{surf}) and the current from the CB domain (i_{S}) as follows:

$${i}_{surf} = - {K}_{NMC} {∇}_{surf} {ϕ}_{S} ,$$

$${∇}_{surf} \cdot ( {si}_{surf} ) = {i}_{S} .$$

The boundary conditions of charge transfer at the electrolyte & NMC interface are:

$${i}_{l} \cdot n = - {i}_{BV} , {i}_{S} \cdot n = {i}_{BV} .$$

The boundary conditions for the mass conservation at the electrolyte & NMC interface give:

$${J}_{l} \cdot n = - \frac{{i}_{BV}}{F} , and {J}_{NMC} \cdot n = \frac{{i}_{BV}}{F} ,$$

where n is the normal unit vector at the specified surfaces. For the homogenized carbon binder domain, porosity is defined as εₗ and the carbon binder fraction is defined as ε_{CB}, εₗ+ε_{CB}=1. Hence using the Bruggeman relationship, the effective bulk transport equations for the electrolyte within the porous carbon binder domain are:

$${D}_{{l}_{eff}} = {{ϵ}_{l}}^{1.5} \cdot {D}_{l}$$

$${K}_{{l}_{eff}} = {{ϵ}_{l}}^{1.5} \cdot {K}_{l}$$

$${K}_{{CB}_{eff}} = {{ϵ}_{l}}^{1.5} \cdot {K}_{CB}$$

The reaction rate constant's (k) contribution towards the charge heterogeneity is minimal in the model, as indicated by the comparison of the composition spatiodynamics using concentration-dependent k values versus a constant k value.

FIG. 12 shows a 3D model of a single surface polished NMC secondary particle in contact with a carbon binder (black outlines) and submerged in the electrolyte. The single 3D particle has a small carbon binder region attached to its curved surface and surrounded by the electrolyte to understand the intraparticle heterogeneity. The intraparticle heterogeneity in the first charging process and subsequent homogeneous Li distribution agreed with the experimental observation. This transition in the compositional spatiodynamics resulted from the incomplete Li intercalation in NMC after the first cycle.

The diffusion anisotropy in the secondary particles contributed to the intra-particle concentration heterogeneity. This effect was apparent as the initial spread of the normalized surface concentration plots during the initial stage of the first charge in FIG. 4D (each plot represents a particle as labeled in FIG. 4A and different lines of the same plot correspond to concentration profile at different positions on that particle's surface). For the 3D model in FIG. 12, the diffusional anisotropy, together with the specific location where the carbon binder contacts with the NMC particle, can influence the front propagation direction. In agreement with the experimental observation, this behavior was shown only during the first charge but not in the further (dis) charge cycles. The local electric potential of the NMC particle (ϕₛ) heavily controlled the time at which the front initiated during the first charge. This, in turn, largely depended on how the electrical conduction barriers (in the form of NMC particle surfaces) were embedded along the electrically conductive path from the current collector. The same behavior of front propagation in experiments using a different electrolyte paired with the NMC532 cathode was also observed.

### CONCLUSIONS

The investigations examined the asynchronous reactions in a solid-solution cathode for Li-ion batteries during the first charge and the transition to the synchronous reactions in subsequent (dis) charge cycles. The operando optical microscopy afforded an easily accessible yet powerful tool to observe the electrochemical behavior of multiple particles of the composite electrode in real-time. The mechanism of the reaction is summarized as follows. (1) The low electrical conductivity of NMC particles in the pristine state creates the spatial variation of the electric field and the reaction rate for the surface charge transfer. The carbon matrix's incomplete coverage of the NMC particles determines the intensity of reaction heterogeneity across the cathode during the first charge. For the first discharge, the relatively higher values of electrical conductivity of NMC drastically diminish the heterogeneity. (2) In agreement with previous studies, the significant variation of Li diffusivity with Li concentration (orders of magnitude lower in the fully lithiated state) is responsible for the capacity loss at the end of the first cycle. Li diffusivity remains at a higher value at the start of the second charge. (3) The incomplete Li intercalation after the first cycle promotes electrical conductivity of the NMC particles in subsequent cycles, resulting in homogeneous electrochemical activities throughout the composite cathode.

From the foregoing, it can be appreciated that the investigations revealed causes for asynchronous reactions in solid-solution cathodes for Li-ion batteries during the first charge and a transition to synchronous reactions in the following (dis) charge cycles. As such, the investigations identified conditions that hindered battery performance. In particular, it was concluded that the investigations indicated a need to increase the electric conductivity of the NMC particles, for example, by coating a thin conductive layer on the particle surfaces, and/or increase the Li diffusivity of the NMC particles, for example, by doping with a foreign element, and/or increase the homogeneity of as fabricated composite electrodes by advanced manufacturing such as field-guided self-assembly, freeze-drying, or printing technologies. As nonlimiting examples, carbon black can be deposited on the surfaces of a NMC cathode to increase its electrical conductivity, and doping with sodium (Na) can be utilized to significantly increase Li diffusivity in a NMC cathode.

As previously noted above, though the foregoing detailed description describes certain aspects of one or more particular embodiments of the invention, alternatives could be adopted by one skilled in the art. For example, the cathodes and their components could differ in appearance and construction from the embodiments described herein and shown in the drawings, functions of certain components of the cathodes could be performed by components of different construction but capable of a similar (though not necessarily equivalent) function, and various materials could be used in the fabrication of the cathodes and/or their components. As such, and again as was previously noted, it should be understood that the invention is not necessarily limited to any particular embodiment described herein or illustrated in the drawings.

1. A method of determining an ion exchange mechanism in a solid-solution cathode of a Li-ion battery, the method comprising:
observing changes in nickel manganese cobalt oxide (NMC) particles of a composite electrode of the Li-ion battery over a period of time using operando optical microscopy;
developing a model of the observed changes using multiphysics computational modeling; and
determining the ion exchange mechanism based on the observed changes and the developed model.

2. The method of claim 1, wherein the step of observing comprises observing Li-reactions of NMC particles from a pristine state to a fully delithiated state during the first charge cycle of the Li-ion battery.

3. The method of claim 2, wherein the ion exchange mechanism is determined to comprise asynchronous Li-reactions in the cathode during the first charge cycle of the Li-ion battery.

4. The method of claim 1, wherein the step of observing comprises observing Li-reactions during the second charge cycle of the Li-ion battery.

5. The method of claim 4, wherein the ion exchange mechanism is determined to comprise at least some synchronous Li-reactions in the cathode during the second charge cycle of the Li-ion battery.

6. The method of claim 1, wherein the step of observing comprises observing Li-reactions during a plurality of charge cycles of the Li-ion battery subsequent to the first charge cycle.

7. The method of claim 6, wherein the ion exchange mechanism is determined to comprise synchronous Li-reactions in the cathode during the second and subsequent charge cycles of the Li-ion battery subsequent to the first charge cycle.

8. The method of claim 1, wherein the composite electrode comprises an NMC cathode.

9. The method of claim 1, wherein the NMC cathode comprises a polished composite electrode of LiNi0.5Mn0.3Co0.2O2 (NMC 532) active material particles, polymer binder, and carbon black conductive additive.

10. The method of claim 1, wherein the step of observing comprises continuously tracking reflected light intensity from the composite electrode.

11. The method of claim 10, wherein tracking reflected light intensity comprises quantifying change in perceived brightness by tracking pixel intensity of one or more specific identified NMC particles in the NMC cathode.

12. The method of claim 11, wherein the step of quantifying comprises calculating an average normalized intensity of the specific identified NMC particles as a function of the cell state of charge (SOC).

13. The method of claim 12, wherein the step of quantifying comprises attributing a directly proportional relationship between an increase in intensity in the perceived brightness and to a decrease in Li concentration.

14. The method of claim 10, wherein the step of observing includes inferring local composition changes during slow charging over cycles from the continuously tracked reflected light intensity.

15. The method of claim 1, wherein the step of developing comprises implementing a spatially varying electric potential across an outer surface of the composite electrode in the model.

16. The method of claim 15, wherein the step of developing comprises creating a 2-D model of cross-section geometry of the composite electrode in which polycrystalline NMC particles are embedded in a carbon network and surrounded by electrolyte, and connected with a cathode current collector, with the NMC particles on an outer surface of the composite electrode experiencing varying degrees of electrical resistance from the carbon network.

17. The method of claim 16, further comprising cycling the 3-D model by enforcing a constant current at a surface of Li source.

18. The method of claim 15, wherein, in the 2-D model, low spatial interconnectivity of carbon binder within the composite electrode and incomplete coverage around NMC particle leads to highly heterogeneous Li distribution throughout the composite electrode.

19. The method of claim 1, wherein the Li-ion battery comprises a fluid cell and a Li metal anode.

20. A method of reducing first charge heterogeneous reactions in a Li-ion battery, the method comprising increasing electrical conductivity of nickel manganese cobalt oxide (NMC) particles in an NMC cathode of the Li-ion battery.

21. The method of claim 20, further comprising optimizing the conductive matrix coverage in the NMC cathode.

22. The method of claim 20, wherein the electrical conductivity of the NMC particles is increased by depositing carbon black on surfaces of the NMC cathode.

23. The NMC cathode of claim 20.

24. A method of reducing first charge heterogeneous reactions in a Li-ion battery, the method comprising increasing Li diffusivity in a nickel manganese cobalt oxide (NMC) cathode of the Li-ion battery.

25. The method of claim 24, wherein the Li diffusivity in the NMC cathode is increased by doping the NMC cathode with sodium (Na).

26. The NMC cathode of claim 24.

27. A method of reducing first charge heterogeneous reactions in a Li-ion battery, the method comprising increasing homogeneity of a nickel manganese cobalt oxide (NMC) cathode of the Li-ion battery by field-guided self-assembly, freeze-drying, and/or a printing technology.

28. The NMC cathode of claim 27.

29. A Li-ion battery comprising a nickel manganese cobalt oxide (NMC) cathode as a porous composite cathode of the Li-ion battery, the NMC cathode comprising a carbon matrix and NMC particles wherein the NMC particles do not completely cover the carbon matrix, intensity of reaction heterogeneity in the NMC cathode is proportional to a value of electrical conductivity of the NMC particles, and incomplete Li intercalation after the first charge cycle promotes electrical conductivity of the NMC particles in subsequent charge cycles, resulting in homogeneous electrochemical activities throughout the porous composite cathode.
